(19) United States
(12) Patent Application Publication
(10) Pub. No.: US 2007/0273118 A1
(43) Pub. Date: Nov. 29, 2007

(54) INLINE SKATEBOARD

(76) Inventor: Amelia Conrad, Topanga, CA (US)

Correspondence Address: KELLY LOWRY & KELLEY, LLP, 6320 CANOGA AVENUE, SUITE 1650, WOODLAND HILLS, CA, 91367, US

(21) Appl. No.: 11/564,427

(22) Filed: Nov. 29, 2006

Related U.S. Application Data
(60) Provisional application No. 60/803,083, filed on May 24, 2006.

(51) Int. Cl. B62M 1/00

(52) U.S. Cl. 280/87.042

(57) ABSTRACT

A skateboard includes a first platform having a first wheel caster. A second platform, co-planar with the first platform, includes a second wheel caster. The skateboard further includes a bar having first and second ends, for interconnecting the first and second platforms in an aligned and spaced-apart relation along a common axis defined by the bar. A first elastomeric plug associated with the first platform is disposed between the bar and the first platform. A second elastomeric plug associated with the second platform is disposed between the bar and the second platform. Each plug allows a respective platform to rotate independently about the common axis.

### BACKGROUND OF THE INVENTION

The present invention generally relates to skateboards. More particularly, the present invention relates to an inline skateboard.

A conventional skateboard typically includes a single platform with two sets of wheels (front and rear) mounted to a bottom surface of the platform. Each wheel-set has a pair of tandem wheels mounted on a single axle set perpendicular to the platform. However, it is difficult to turn and steer the conventional skateboard as the conventional skateboard can only be steered to the left or right direction by a rider applying lateral forces to the platform (i.e., leaning their body to either the left or right side of the platform, much as a snow skier does to change direction) which cause the wheels of skateboard to rotate into the direction in which the rider is applying lateral forces (i.e., leaning). However, the tandem wheels of the wheel-sets are designed to simultaneously ride upon the ground surface and this turning technique creates a problem as the conventional skateboard cannot be tilted much to the left or to the right (i.e., up or down) as this can cause the platform to contact the wheel of the wheel-set on the side on which the rider is learning when the platform is tilted more than a specific angle. The contact between the platform and the wheel creates a braking friction that can stop the wheel from turning. This limits the ability of the rider to steer the conventional skateboard with both wheel-sets at least partially touching the ground and prevents the rider from being able to change the direction of the skateboard within a small turning radius.

In order to solve the problems of skateboard turning related to the nature of the pairs of tandem wheels, inline skates, in which a number of wheels are located in an inline arrangement, have been developed. For example, U.S. Pat. No. 6,428,022 provides a skateboard having two wheels in tandem with one at the front of the skateboard and the other at the rear of the skateboard. This inline skateboard provides improvement in the ability of a rider to turn and maneuver the skateboard as tandem wheels are no longer employed. However, this inline skateboard includes a single platform which limits the overall flexibility and maneuverability of the skateboard.

Skateboards have been developed that provide dual platforms. For example, U.S. Pat. No. 4,082,306 discloses a torsion bar skateboard having separate front and rear platforms. However, the disclosed skateboard utilizes tandem wheels which have all of the drawbacks that come with the use of tandem wheels.

Accordingly, there is a need for an inline skateboard which provides improved maneuverability and turning capabilities. There is also a need for a skateboard having wheels which steer both in the front of the skateboard and in the rear of the skateboard. There is an additional need for a skateboard having dual platforms that provide additional flexibility. The present invention satisfies these needs and provides other related advantages.

### SUMMARY OF THE INVENTION

The present invention provides an inline skateboard having dual platforms upon which a rider stands during use. Each platform has an associated wheel caster, and a bar interconnects the first and second platforms in an aligned and spaced-apart relation along a common axis defined by the bar. Elastomeric plugs associated with the platforms are disposed between the bar and the platforms, allowing the platforms to rotate independently about the common axis.

The first platform includes a bore within which a first elastomeric plug is disposed to receive a first end of the bar. The first plug flexes relative to the common axis which in turn allows the first platform to rotate about the common axis. The first plug expands to wedge against the bore of the first platform as the first plug receives the first end of the bar. The bore of first platform is configured to prevent rotation of the first elastomeric plug therein.

The second platform includes a bore within which a second elastomeric plug is disposed to receive a second end of the bar. The second plug flexes relative to the common axis which in turn allows the second platform to rotate about the common axis. The second plug expands to wedge against the bore of second platform as the second plug receives the second end of the bar. The bore of second platform is configured to prevent rotation of the second elastomeric plug therein.

Locks are also provided for securing the elastomeric plugs to the respective platforms. Each elastomeric plug includes a recess for receiving a respective end of the bar and is configured to prevent rotation of the bar relative to the respective recess.

Each wheel caster freely rotates only up to about one hundred sixty degrees and includes a mechanism that limits rotation of the wheel caster. Each wheel caster includes a mechanism for automatically aligning the wheel caster with the common axis.

Each platform of the skateboard includes a caster support on a bottom surface thereof such that the caster extends from the support at an angle ranging from about thirty to sixty degrees relative to the bottom surface of the platform.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a top and side perspective view of a skateboard embodying the invention;

FIG. 2 is a bottom and side perspective view of the skateboard of FIG. 1;

FIG. 3 is a top plan view of the skateboard of FIGS. 1 and 2;

FIG. 4 is a bottom plan view of the skateboard of FIGS. 1 and 2;

FIG. 5 is a bottom plan view similar to that of FIG. 4, illustrating rotational movement of the skateboard's wheel casters;

FIG. 6 is an exploded perspective view similar to FIG. 2, with a portion of a sleeve about a bar between front and rear portions of the skateboard cutaway for clarity;

FIG. 7 is a side elevation view of the skateboard of FIGS. 1 and 2;

FIG. 8 is a sectional view taken generally along line 8-8 of FIG. 3;

FIG. 9 is a perspective view of a wheel caster;

FIG. 10 is an exploded view of the wheel caster of FIG. 9; and

FIG. 11 is a top plan view taken generally along line 11-11 of FIG. 9, illustrating rotational movement of the wheel caster.

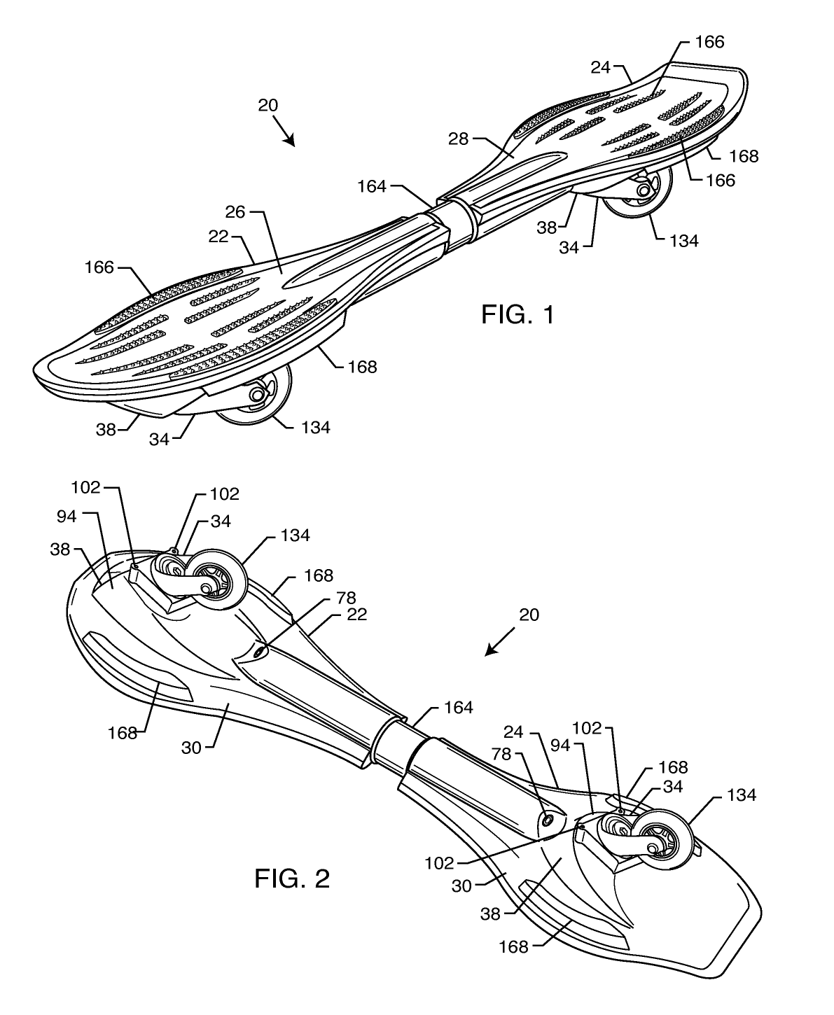

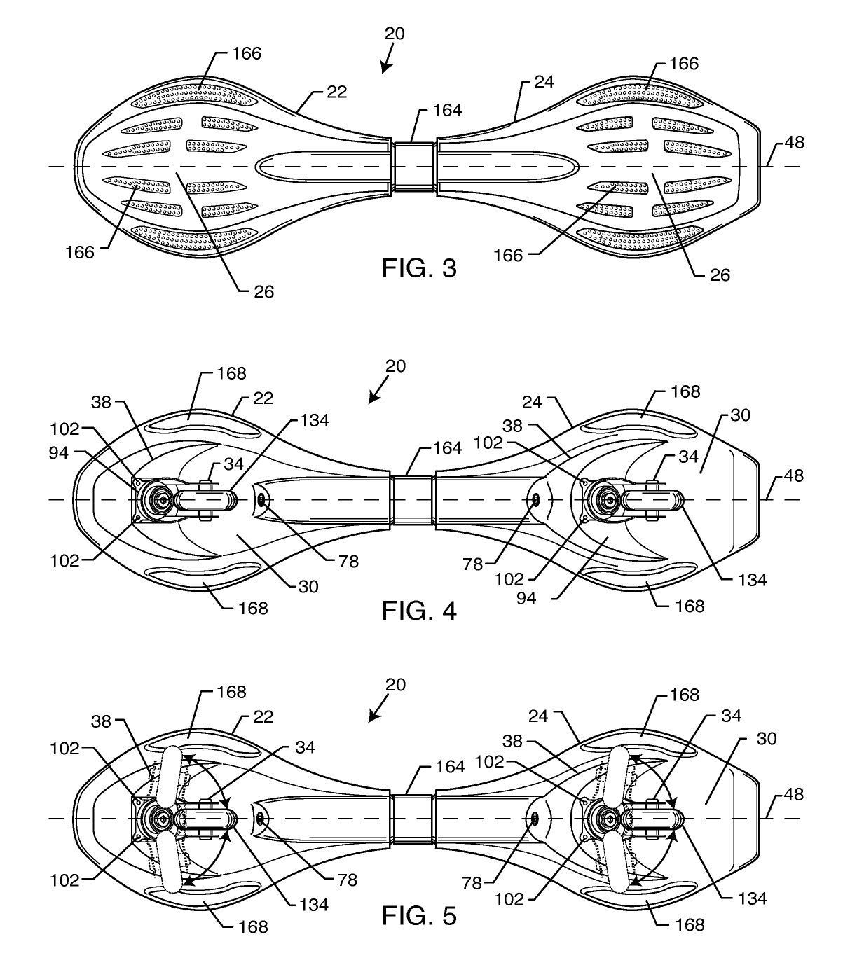

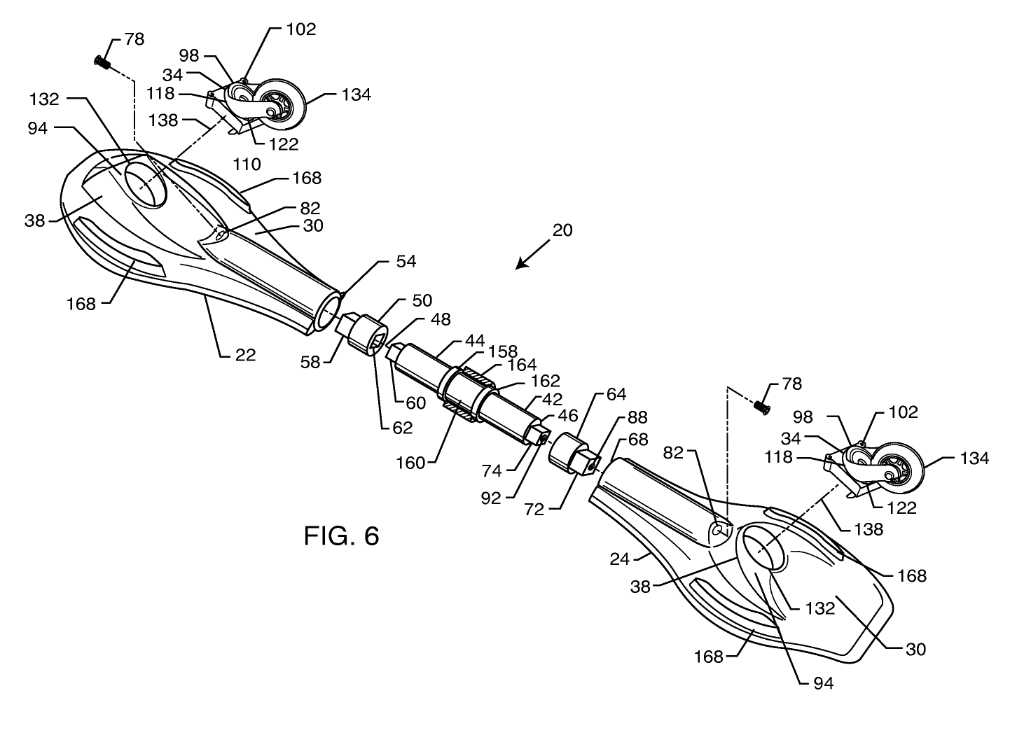

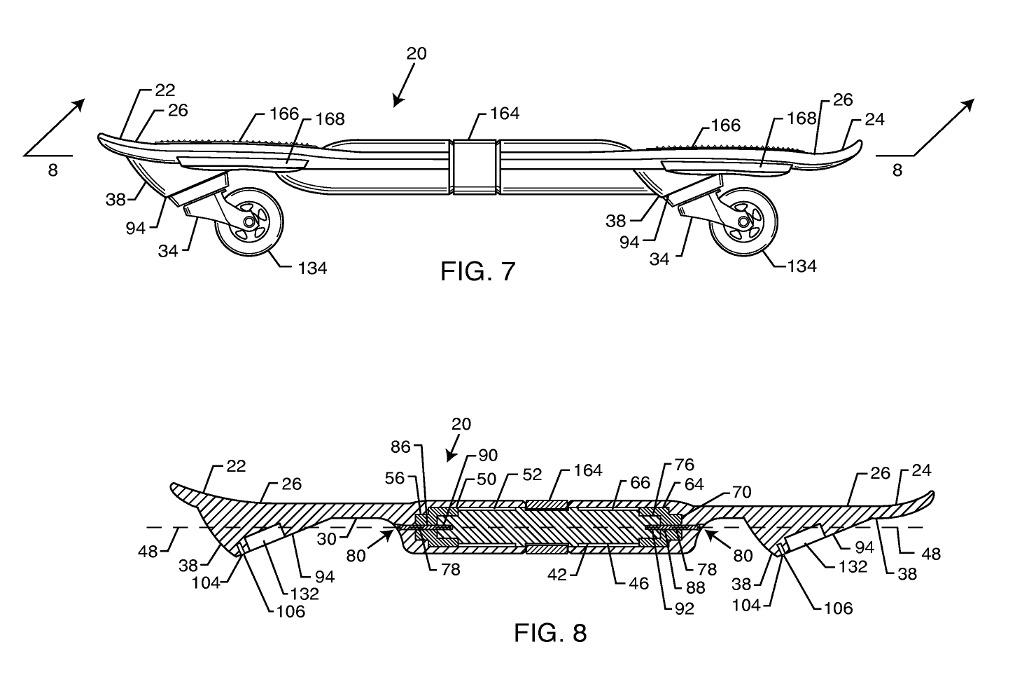

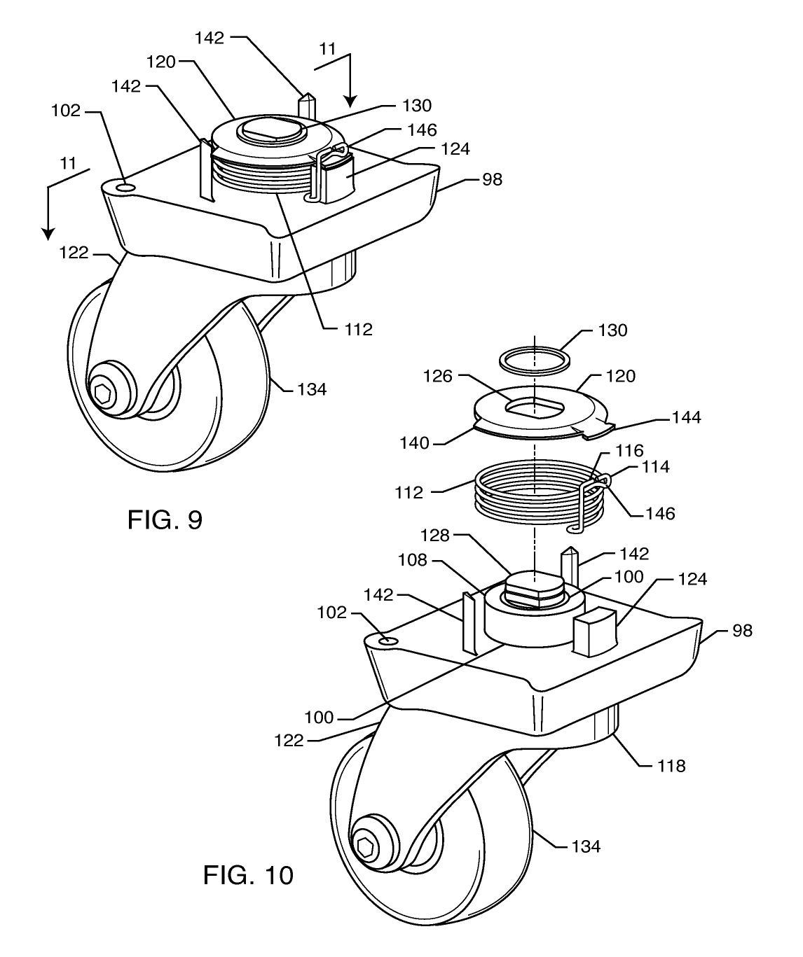

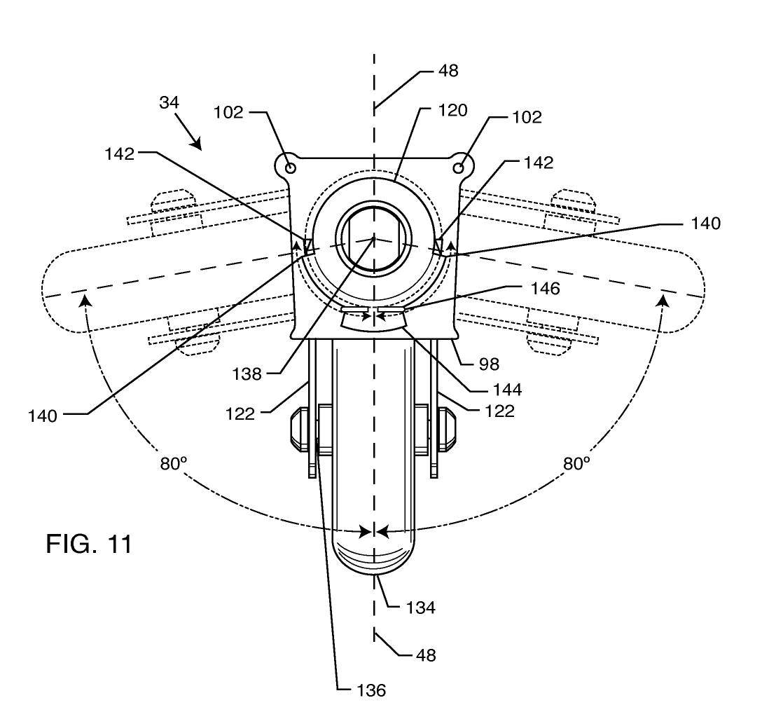

### DETAILED DESCRIPTION OF THE PREFERRED EMBODIMENT

As shown in the drawings for purposes of illustration, the present invention resides in a skateboard, generally referred to by reference number 20. The skateboard 20 includes front and rear interconnected co-planar platforms 22 and 24. The platforms 22 and 24 may be made from various materials including, but not limited to, wood, metal, plastic or a carbon/fiberglass composite material.

Each platform 22, 24 includes a relatively flat top surface 26, a bottom surface 30 and a wheel caster 34 connected to the bottom surface 30. A front end of the front platform 22 and a rear end of the rear platform are upwardly curved. Each platform 22, 24 of the skateboard 20 also includes a wedge-shaped wheel caster support 38 on the bottom surface 30 thereof such that the wheel caster 34 extends from the support 38 at an angle ranging from about thirty to sixty degrees relative to the bottom surface 30 of the respective platform 22, 24.

The front and rear platforms 22, 24 are interconnected by a bar 42 having front and rear platform-engaging ends 44, 46. The bar 42 interconnects the front and rear platforms 22, 24 in an aligned, spaced-apart relation along a common axis 48 defined by the bar 42. The bar 42 may be made from various materials including, but not limited to, metal, plastic or a carbon/fiberglass composite material.

A first elastomeric plug 50 associated with the front platform 22 is disposed between the bar 42 and the front platform 22. The front platform 22 includes a bore 52 having an opening 54 facing the rear platform 24. The first elastomeric plug 50 is disposed within the bore 52 in order to receive the front end 44 of the bar 42. The bore 52 is configured to prevent rotation of the first elastomeric plug 50 therein by incorporating a square-shaped recess 56 within which a corresponding square-shaped protrusion 58 of the first elastomeric plug 50 is disposed. Moreover, the front end 44 of the bar 42 includes a square-shaped protrusion 60, and the first elastomeric plug 50 includes a corresponding square-shaped recess 62 for receiving the protrusion 60. The first elastomeric plug 50 expands to wedge against the bore 52 of the front platform 22 as the first elastomeric plug 50 receives the front end 44 of the bar 42. This engagement of the first elastomeric plug 50 with the front platform 22 and the bar 42 allows the first elastomeric plug 50 to rotationally flex relative to the common axis 48 which in turn allows the front platform 22 to rotate about the common axis 48.

Likewise, a second elastomeric or plug 64 associated with the rear platform 24 is disposed between the bar 42 and the rear platform 24. The rear platform 24 includes a bore 66 having an opening 68 facing the front platform 22. The second elastomeric plug 64 is disposed within the bore 66 in order to receive the rear end 46 of the bar 42. The bore 66 is configured to prevent rotation of the second elastomeric plug 64 therein by incorporating a square-shaped recess 70 within which a corresponding square-shaped protrusion 72 of the second elastomeric plug 64 is disposed. Moreover, the rear end 46 of the bar 42 includes a square-shaped protrusion 74, and the second elastomeric plug 64 includes a corresponding square-shaped recess 76 for receiving the protrusion 74. The second elastomeric plug 64 expands to wedge against the bore 66 of the rear platform 24 as the second elastomeric plug 64 receives the rear end 46 of the bar 42. The engagement of the second elastomeric plug 64 with the rear platform 24 and the bar 42 allows the second elastomeric plug 64 to rotationally flex relative to the common axis 48 which in turn allows the rear platform 24 to rotate about the common axis 48.

The first and second elastomeric plugs 50, 64 are coaxial with the bar 42 along the common axis 48. The plugs 50, 64 and bar 42 are secured together which, in turn, secures the platforms 22, 24 and bar 42 together. Each plug 50, 64 is configured to prevent rotation of the bar 42 relative to a respective recess 62, 76 which, in turn, allows a respective platform 22, 24 to rotate about the common axis 48, independent of the other platform 24, 22. The plugs 50, 64 may be made from various elastomeric materials including, but not limited to, plastic, rubber or the like.

Lock bolts 78 secure the elastomeric plugs 50 and 64 to the respective platforms 22, 24. Each lock bolt 78 is disposed within a threaded bore 80 in a respective platform 22, 24 that extends coaxially with the common axis 48 into a respective recess 56, 70 of the bore 52, 66. Each square-shaped protrusion 58, 72 of the plug 50, 64 includes a threaded bore 86, 88 aligned with the threaded bore 80 of the respective platform 22, 24 when the plug 50, 64 is disposed within the respective recess 56, 70. Each square-shaped protrusion 60, 74 of the bar 42 includes a threaded bore 90, 92 that are also aligned with the threaded bore 80 of the respective platform 22, 24 when the square-shaped protrusion 60, 74 is disposed within its respective square-shaped recess 62, 76. The lock bolts 78 are then inserted into the respective aligned bores 80, 86, 88, 90, 92 and threadedly engaged therewith. In the alternative, each lock bolt 78 may be disposed within a threaded bore in a respective platform 22, 24 that extends perpendicularly from the bottom surface 30 of the platform 22, 24 to engage a respective recess 56, 70 of the bore 52, 66. Each square-shaped protrusion 58, 72 includes a threaded bore perpendicular to the common axis 48, aligned with the threaded bore of the respective platform 22, 24 when the plug 50, 64 is disposed within the respective recess 56, 70. The lock bolts 78 are then inserted into the respective aligned bores and threadedly engaged therewith. An adhesive is disposed within a respective square-shaped recess 62, 76 of the plugs 50, 64 in order to connect the bar 42 to the plugs 50, 64 when the square-shaped protrusions 60, 74 are disposed within the respective square-shaped recess 62, 76.

The wedge-shaped wheel caster supports 38 extend from the bottom surface 30 of respective platforms 22, 24 such that each wheel caster 34 extends from a respective support 38 at an acute angle ranging from about thirty to sixty degrees relative to the bottom surface 30 of the respective platform 22, 24. Each wheel caster support 38 has a caster-engaging angled surface 94 ranging from about thirty to sixty degrees relative to the common axis 48.

The wheel caster 34 includes a wheel caster support plate 98 having a central bore 100. Threaded fasteners (not shown) are inserted through bores 102 in the support plate 98 when the bores 102 are aligned with respective threaded bores 104 having respective apertures 106 on the caster-engaging angled surface 94 in order to secure each wheel caster 34 to a respective wheel caster support 38.

Each wheel caster 34 further includes a roller arm plate 118 having pair of roller arms 122 and a cylindrical mount 108 inserted through the central bore 100 in order to secure the roller arm plate 118 to the support plate 98 such that the roller arm plate 118 is able to rotate within the bore 100.

A torsional spring 112 is disposed about and engages the cylindrical mount 108. Ends 114, 116 of the spring 112 engage a post 124 extending away from the support plate 98. A stationary non-rotatable washer 120 having a central aperture 126 is disposed adjacent a portion of the cylindrical mount 108 with the spring 112 disposed between the washer 120 and the support plate 98. The upper portion of the roller arm plate 118 engages a cap 128. A retaining ring 130 is disposed about the cap 128 on top of the washer 120 in order to retain the washer 120 in position. The spring 112 resists rotational movement of the roller arm plate 118 relative to the support plate 98.

A ground-engaging roller 134 is rotatably connected to the roller arms 122 by an axle 136 extending between the pair of roller arms 122, in a conventional manner. The aperture 100 of each wheel caster support plate 98, the central aperture 126 of each washer 120, and a bore 132 of each wheel support 38 are coaxial along a respective wheel caster common axis 138. As outlined above, the caster 34 is then held in position with respect to the bore 132 by connecting the support plate 98 to the wheel support 38 via fasteners (not shown) inserted through aligned apertures 102, 104. Each roller arm plate 118 is connected to the wheel caster support plate 98 and includes a conventional ball-bearing roller assembly, allowing each wheel caster 34 to freely rotate about the wheel caster common axis 138 relative to the support plate 98. However, each washer 120 includes two flanges or stops 140 that extend outwardly from opposite sides of the washer 120 (i.e., one hundred eighty degrees apart) that limit rotation of the wheel caster roller arm plate 118 by no more than about eighty degrees relative to the common axis 48 and/or the wheel caster common axis 138. The pair of roller arms 122 pivot with the roller arm plate 118 about the wheel caster common axis 138 relative to the caster support plate 98. Each support plate 98 includes a pair of elongated protrusions 142 extending away from the support plate 118. The protrusions 142 are stationary, disposed on opposite sides of the support plate 98. However, engagement of the protrusions 142 with the stops 140 allows the roller arm plate 118, the pair of roller arms 122 and the roller 134 to freely rotate about the wheel caster common axis 138 only up to about one hundred sixty degrees between the two stops 140. The rotation of the roller arm plate 118, the pair of roller arms 122 and the roller 134 about the wheel caster common axis 138 can be increased closer to one hundred eighty degrees by adjusting the dimensions of the stops 140 and/or the diameter of the protrusion 142. In the alternative, the protrusion 142 can be in the form of a rectangular flange, a pyramidal projection or the like. Limiting rotation of the rollers 134 about the wheel caster common axis 138 prevents the axles 136 holding the rollers 134 from becoming parallel to the common axis 48 (and hence the rollers 134 from becoming perpendicular to the common axis 48). The axles 136 of the rollers 134 becoming parallel to the common axis 48 can result in catastrophic braking and/or stoppage of the skateboard 20 if, at the time this happens, the skateboard 20 board is moving in a direction generally parallel to the common axis 48 since that movement is perpendicular to the direction in which the rollers 134 turn about the axles 136. Limitation of the rotation of the wheel casters 34 improves the ability to turn and maneuver the skateboard 20 by reducing the possibility of an unexpected braking. Each spring 120 is positioned internally within the platform 22, 24.

A projection 144 of the washer 120 engages a loop 146 formed by the end 114 of the spring 112 that aids in preventing the spring 112 from moving out of position. The central aperture 126 of the washer 120 is sized and shaped to receivingly engage the upper mount 108 in a nonrotatable fashion about the upper mount 108. In this manner, the spring 112 is held in position but still able to rotate with the roller arm plate 118. The spring 112 resists rotation such that the spring acts as a means for automatically aligning the wheel caster 34 with the common axis 48 by torsionally pivoting the roller arm plate 118 and roller arms 122 about the common axis 138 until the wheel 134 is aligned with the common axis 48. When each wheel caster 34 engages a respective platform 22, 24, the spring 112, mount 108, washer 120, retaining ring 130 and the like of each wheel caster 34 is disposed within the bore 132 of a respective platform 22, 24.

In the alternative, another embodiment of the wheel caster 34 includes an annular stationary washer having a central aperture where the stationary washer can be disposed between the roller arm plate 118 and the wheel caster support 98. A threaded fastener holds the stationary washer in position when the threaded fastener is inserted through a central aperture of the wheel caster support plate 98, then through the central aperture of the stationary washer (the fastener then being threadedly engaged with a nut (e.g., a hex nut) disposed between the stationary washer and the caster-engaging angled surface 94) and into the bore 132 (in this case, a threaded bore) of the wheel caster support 38 for threaded engagement therewith. The engagement of the threaded fastener with the aforementioned components holds the washer tightly between the roller arm plate 118 and the wheel caster support plate 98. Each roller arm plate 118 is pivotably connected to the wheel caster support plate 98 in a conventional manner (e.g., via a ball-bearing roller assembly attached to the wheel caster support plate 98) allowing each wheel caster 34 to freely rotate about the wheel caster common axis 138. However, each stationary washer includes two flanges or stops that extend outwardly from opposite sides of the washer (i.e., one hundred eighty degrees apart) that limit rotation of the wheel caster roller arm plate 118 by no more than about eighty degrees relative to the common axis 48 and/or the wheel caster common axis 138. The pair of roller arms 122 pivot with the roller arm plate 118 about the wheel caster common axis 138 relative to the caster support plate 98. Each roller arm plate 118 includes a cylindrical protrusion extending from the roller arm plate 118 generally towards the caster-engaging angled surface 94 of the wheel caster support 38. The protrusion pivots with the roller arm plate 118 about the wheel caster common axis 138 relative to the wheel caster support plate 98. However, engagement of the protrusion with a side of the stops allows the roller arm plate 118, the pair of roller arms 122 and the roller 134 to freely rotate about the wheel caster common axis 138 only up to about one hundred sixty degrees between the two stops. The rotation of the roller arm plate 118, the pair of roller arms 122 and the roller 134 about the wheel caster common axis 138 can be increased closer to one hundred eighty degrees by adjusting the width of the stops and/or the diameter of the protrusion. The protrusion can also be in the form of a rectangular flange, a pyramidal projection or the like.

The interconnecting bar 42 further includes a front annular ring 158 disposed between an intermediate section 160 of the bar 42 and the front platform-engaging end 44 of the bar 42. Likewise, the bar 42 also includes a rear annular ring 162 disposed between the intermediate section 160 of the bar 42 and the rear platform-engaging end 46 of the bar 42. The front annular ring 158 fits within the bore 52 of the front platform 22 and the rear annular ring 162 fits within the bore 66 of the rear platform 24. A hollow cylindrical sleeve 164 is disposed about the intermediate section 160 of the bar 42 between the front and rear annular rings 158, 162. An outer diameter of the sleeve 164 is larger than an outer diameter of the bores 52, 66 of the front and rear platforms 22, 24 and an inner diameter of the sleeve 164 is larger than the diameter of the intermediate section 160 but smaller than an outer diameter of the front and rear annular rings 158, 162 so that the sleeve 164 is contained between the rings 158, 162. This allows the sleeve 164 to serve as a spacer between the front and rear platforms 22, 24.

The top surface 26 of each platform 22, 24 includes a number of foot grip pads 166 that provide additional frictional contact between the feet of the rider and the top surface 26 of each platform 22, 24. Additionally, a pair of braking pads 168 are disposed on opposite sides of each platform 22, 24.

In use, a rider using the skateboard 20 described above, can lean the front platform 22 to its right side with respect to the advancing direction of the skateboard 20. When the rider leans on the right side of the front platform 22, the leaning causes the first elastomeric plug 50 to flex and rotate about the common axis 48 in the direction in which the rider is leaning. This, in turn, causes the roller arms 122 of the wheel caster 34 to turn to the left side and the roller 134 rolls to the right direction with respect to the direction of forward movement, so that the rider can turn to the right direction. On the other hand, if the rider leans the rear platform 24 on its right side with respect to the direction of forward movement, the leaning causes the second elastomeric plug 64 to flex and rotate about the common axis 48 in the direction in which the rider is leaning which, in turn, causes the roller arms 122 of the wheel caster 34 to turn to the left side and the roller 134 rolls to the right with respect to the direction of forward movement, so that the rear platform 24 turns to the right, with the result that the rider can turn to the left direction. The two effects can be combined when the rider leans the front platform 22 to its right side and the rear platform 24 to its left side with respect to the direction of forward movement. This enables the rider to turn to the right direction within a relatively small turning radius as compared with conventional skateboards. Also, if the rider leans the front and rear platforms 22, 24 to the same lateral side with respect to the advancing direction, the rider can advance in that direction with both the front and rear platforms 22, 24 advancing in parallel. The elastomeric interconnection of the front and rear platforms 22, 24 allows each platform 22, 24 to rotational flex about the common axis 48 independent of the other platform 24, 22.

Although an embodiment has been described in detail for purposes of illustration, various modifications may be made to each without departing from the scope and spirit of the invention. Accordingly, the invention is not to be limited, except as by the appended claims.

What is claimed is:

1. A skateboard, comprising:
a first platform including a first wheel caster;
a co-planar second platform including a second wheel caster;
a bar having first and second ends, for interconnecting the first and second platforms in an aligned and spaced-apart relation along a common axis defined by the bar;
a first elastomeric plug associated with the first platform, disposed between the bar and the first platform; and
a second elastomeric plug associated with the second platform, disposed between the bar and the second platform;
wherein each plug allows a respective platform to rotate independently about the common axis.

2. The skateboard of claim 1, wherein the first platform includes a bore within which the first elastomeric plug is disposed to receive the first end of the bar; the first plug flexing relative to the common axis which in turn allows the first platform to rotate about the common axis.

3. The skateboard of claim 2, wherein the first plug expands to wedge against the bore of the first platform as the first plug receives the first end of the bar.

4. The skateboard of claim 2, wherein the bore of first platform is configured to prevent rotation of the first elastomeric plug therein.

5. The skateboard of claim 1, wherein the second platform includes a bore within which the second elastomeric plug is disposed to receive the second end of the bar, the second plug flexing relative to the common axis which in turn allows the second platform to rotate about the common axis.

6. The skateboard of claim 5, wherein the second plug expands to wedge against the bore of second platform as the second plug receives the second end of the bar.

7. The skateboard of claim 5, wherein the bore of second platform is configured to prevent rotation of the second elastomeric plug therein.

8. The skateboard of claim 1, including a first lock for securing the first elastomeric plug to the first platform, and a second lock for securing the second elastomeric plug to second platform.

9. The skateboard of claim 1, wherein each elastomeric plug includes a recess for receiving a respective end of the bar and is configured to prevent rotation of the bar relative to the respective recess.

10. The skateboard of claim 1, wherein each wheel caster freely rotates only up to about one hundred sixty degrees.

11. The skateboard of claim 1, wherein each wheel caster includes means for limiting rotation of the wheel.

12. The skateboard of claim 1, wherein each platform includes a caster support on a bottom surface thereof, wherein the wheel caster extends from the support at an angle ranging from about thirty to sixty degrees relative to the bottom surface of the platform.

13. The skateboard of claim 1, wherein each wheel caster includes means for automatically aligning the wheel caster with the common axis.

14. A skateboard, comprising:
a first platform including a first wheel caster freely rotatable only up to about one hundred sixty degrees;
a co-planar second platform including a second wheel caster freely rotatable only up to about one hundred sixty degrees;
a bar having first and second ends, for interconnecting the first and second platforms in an aligned and spaced-apart relation along a common axis defined by the bar;
a first elastomeric plug associated with the first platform, disposed between the bar and the first platform; and
a second elastomeric plug associated with the second platform, disposed between the bar and the second platform;
wherein each elastomeric plug includes a recess for receiving a respective end of the bar and is configured to prevent rotation of the bar relative to the respective recess while allowing a respective platform to rotate independently about the common axis.

15. The skateboard of claim 13, wherein the first platform includes a bore within which the first elastomeric plug is disposed to receive the first end of the bar; the first plug expanding to wedge against the bore of the first platform as the first plug receives the first end of the bar and flexing relative to the common axis which in turn allows the first platform to rotate about the common axis, and wherein the bore of first platform is configured to prevent rotation of the first elastomeric plug therein.

16. The skateboard of claim 13, wherein the second platform includes a bore within which the second elastomeric plug is disposed to receive the second end of the bar; the second plug expanding to wedge against the bore of second platform as the second plug receives the second end of the bar and flexing relative to the common axis which in turn allows the second platform to rotate about the common axis, and wherein the bore of second platform is configured to prevent rotation of the second elastomeric plug therein.

17. The skateboard of claim 13, including a first lock for securing the first elastomeric plug to the first platform, and a second lock for securing the second elastomeric plug to second platform.

18. The skateboard of claim 1, wherein each wheel caster includes means for automatically aligning the wheel caster with the common axis and means for limiting rotation of the wheel caster; each platform including a caster support on a bottom surface thereof, wherein the wheel caster extends from the support at an angle ranging from about thirty to sixty degrees relative to the bottom surface of the platform.

19. A skateboard, comprising:
a first platform including a first wheel caster freely rotatable only up to about one hundred sixty degrees;
a co-planar second platform including a second wheel caster freely rotatable only up to about one hundred sixty degrees;
a bar having first and second ends, for interconnecting the first and second platforms in an aligned and spaced-apart relation along a common axis defined by the bar;
a first elastomeric plug associated with the first platform, disposed between the bar and the first platform;
a first lock for securing the first elastomeric plug to the first platform;
a second elastomeric plug associated with the second platform, disposed between the bar and the second platform; and
a second lock for securing the second elastomeric plug to second platform;
wherein each elastomeric plug includes a recess for receiving a respective end of the bar and is configured to prevent rotation of the bar relative to the respective recess while allowing a respective platform to rotate independently about the common axis;
wherein each wheel caster includes means for automatically aligning the wheel caster with the common axis and means for limiting rotation of the wheel; each platform including a caster support on a bottom surface thereof, wherein the wheel caster extends from the support at an angle ranging from about thirty to sixty degrees relative to the bottom surface of the platform.

20. The skateboard of claim 18, wherein the first platform includes a bore within which the first elastomeric plug is disposed to receive the first end of the bar; the first plug expanding to wedge against the bore of the first platform as the first plug receives the first end of the bar and flexing relative to the common axis which in turn allows the first platform to rotate about the common axis, and wherein the bore of first platform is configured to prevent rotation of the first elastomeric plug therein.

21. The skateboard of claim 18, wherein the second platform includes a bore within which the second elastomeric plug is disposed to receive the second end of the bar; the second plug expanding to wedge against the bore of second platform as the second plug receives the second end of the bar and flexing relative to the common axis which in turn allows the second platform to rotate about the common axis, and wherein the bore of second platform is configured to prevent rotation of the second elastomeric plug therein.
